(19) United States
(12) Patent Application Publication
(10) Pub. No.: US 2014/0346851 A1
(43) Pub. Date: Nov. 27, 2014

(54) BRAKE DEVICE

(71) Applicant: HITACHI AUTOMOTIVE SYSTEMS, LTD., Hitachinaka-shi, Ibaraki (JP)

(72) Inventors: Hiroki Sonoda, Atsugi-shi (JP); Toshiya Oosawa, Yokohama-shi (JP); Akira Takahashi, Isehara-shi (JP); Asahi Watanabe, Fujisawa-shi (JP)

(21) Appl. No.: 14/367,075

(22) PCT Filed: Dec. 11, 2012
(86) PCT No.: PCT/JP2012/082054

§ 371 Date: Jun. 19, 2014

(30) Foreign Application Priority Data
Dec. 20, 2011 (JP) 2011-278672

(51) Int. Cl. B60L 7/18; B60T 8/176; B60T 13/14

(52) U.S. Cl. CPC B60L 7/18; B60T 13/142; B60T 8/176
USPC 303/3

(57) ABSTRACT

A brake device used in a vehicle employing a regenerative braking device for applying an electric braking force to road wheels, is provided with a first pump for sucking brake fluid from a master cylinder for generating a brake fluid pressure by a brake operation of the driver and for increasing a wheel-cylinder fluid pressure of a front-wheel system so as to generate a braking force, and a second pump for sucking the brake fluid from a reservoir, and for increasing a wheel-cylinder fluid pressure of a rear-wheel system so as to generate a braking force. Also provided is a brake control unit for calculating a distribution amount among the braking forces respectively produced by the first pump, the second pump, and the regenerative braking device in order to generate a required braking force depending on the brake operation by the driver.

### TECHNICAL FIELD

The present invention relates to a brake device.

### BACKGROUND ART

In a conventional brake device, a brake system that uses a booster for multiplying a leg-power on a brake pedal by a driver is applied to one system, whereas a brake-by-wire system is applied to the other system. One example of related techniques as discussed previously has been disclosed in Patent document 1.

In the conventional brake device, it would be desirable to enhance an energy recovery efficiency by a regenerative braking device.

### CITATION LIST

### Patent Literature

Patent document 1: Japanese patent provisional publication No. 2005-119427 (A)

### SUMMARY OF INVENTION

It is, therefore, in view of the previously-described drawbacks of the prior art, an object of the invention to provide a brake device capable of enhancing an energy recovery efficiency during braking.

According to the present invention, one system is constructed by a brake system in which a brake fluid pressure generated by a brake operation of a driver is increased by means of a first pump and the increased brake fluid pressure is supplied to a wheel cylinder, whereas the other system is constructed by a brake-by-wire system in which a pressure of brake fluid in a reservoir is increased by means of a second pump and the increased brake fluid pressure is supplied to a wheel cylinder.

Therefore, in the brake device of the invention, it is possible to enhance the energy recovery efficiency during braking.

### BRIEF DESCRIPTION OF DRAWINGS

FIG. 1 is a system block diagram of a hybrid vehicle on which a brake device of the first embodiment is mounted.

FIG. 2 is a hydraulic circuit diagram illustrating the circuit configuration of a hydraulic control unit in the first embodiment.

FIG. 3 is a flowchart illustrating the control flow of regenerative cooperation control processing executed within a brake control unit.

FIG. 4 is a calculation map of a fore-and-aft braking-force distribution amount during braking straight ahead.

FIG. 5 is a time chart illustrating operation of the hydraulic control unit in the case that a required braking force is changing within a region “a” in FIG. 4.

FIG. 6 is a time chart illustrating operation of the hydraulic control unit in the case of a transition of a required braking force from the region “•” to the region “b” in FIG. 4.

FIG. 7 is a time chart illustrating operation of the hydraulic control unit in the case of a transition of a required braking force from the region “•” via the region “•” to the region “c” in FIG. 4.

FIG. 8 is a hydraulic circuit diagram illustrating the circuit configuration of a hydraulic control unit in the second embodiment.

FIG. 9 is a hydraulic circuit diagram illustrating the circuit configuration of a hydraulic control unit in the third embodiment.

FIG. 10 is a hydraulic circuit diagram illustrating the circuit configuration of a hydraulic control unit in the fourth embodiment.

FIG. 11 is a hydraulic circuit diagram illustrating the circuit configuration of a hydraulic control unit in the fifth embodiment.

### DESCRIPTION OF EMBODIMENTS

A mode for carrying out a brake device according to the invention is hereinafter described in reference to the embodiments shown in the drawings.

By the way, the embodiments, which are hereinbelow explained, are studied to be suited to several needs. Enhancing the energy recovery efficiency is one of the studied needs. That is, the following embodiments are further suitable for the need for enhancing a braking efficiency, the need for stabilizing a cornering behavior (a turning behavior), and the need for enhancing a fail-safe performance.

### First Embodiment

First of all, the configuration is hereunder described.

### System Configuration

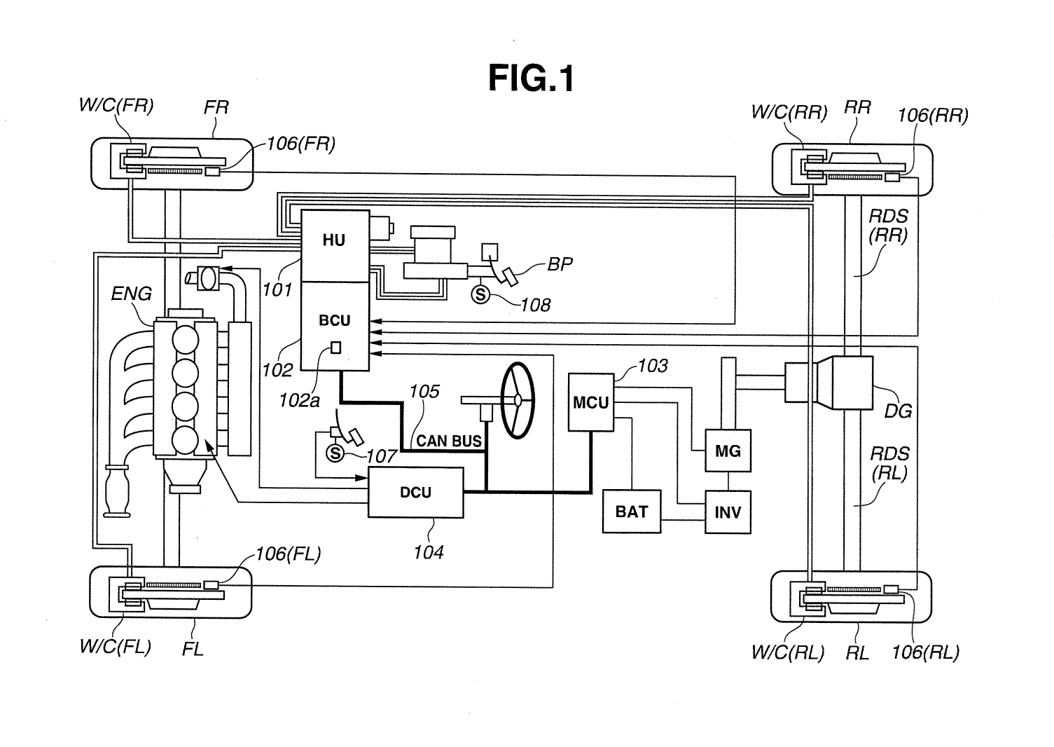

FIG. 1 is the system block diagram of a hybrid vehicle on which a brake device of the first embodiment is mounted.

A hydraulic control unit (HU) 101 is configured to hold, increase, or decrease, based on each road-wheel fluid-pressure command sent from a brake control unit (BCU) 102, each fluid pressure of a wheel cylinder W/C(FL) of a front-left road wheel FL, a wheel cylinder W/C(RR) of a rear-right road wheel RR, a wheel cylinder W/C(FR) of a front-right road wheel FR, and a wheel cylinder W/C(RL) of a rear-left road wheel RL.

A regenerative braking device, which generates a regenerative braking force applied to rear-left and rear-right road wheels RL-RR, is constructed by a motor generator MG, an inverter INV, and a battery BAT.

MG 103 is connected through a rear driveshaft RDS(RL) of the rear-left road wheel RL and a rear driveshaft RDS(RR) of the rear-right road wheel RR, and a differential gear DG to the respective rear road wheels. In response to a command from a motor control unit (MCU) 103, the motor generator operates between a power-running mode at which a driving force acting on each of rear wheels RL-RR is generated and an energy-regeneration mode at which a regenerative braking force acting on each of the rear wheels is generated.

Inverter INV is configured to feed electricity to the motor generator MG, while converting an electric power of battery BAT, when motor generator MG is operating at a power-running mode. Conversely when motor generator MG is operating at an energy-regeneration mode, the inverter operates to convert an electric power generated by the motor generator MG for charging the battery BAT.

MCU 103 is configured to operate the motor generator MG at a power-running mode in response to a command from a drive controller (DCU) 104. The motor control unit is also configured to operate the motor generator MG at an energy-regeneration mode in response to a regenerative-braking-force command from the BCU 102. MCU 103 is configured to send information about a state of output control for a regenerative braking force or a driving force of motor generator MG and a maximum possible regenerative braking force through a CAN communication line 105 to the BCU 102 and the DCU 104.

Hereupon, “the maximum possible regenerative braking force” is calculated or derived from a battery's state of charge SOC, and a vehicle-body speed (vehicle speed), calculated (estimated) based on information from wheel speed sensors 106(FL, FR, RL, RR) installed on respective road wheels FL, FR, RL, and RR. Additionally, during cornering, information about steer characteristics is also added.

When battery BAT is in a fully-charged state or almost in a fully-charged state, from the viewpoint of a battery life it is necessary to prevent overcharge. Also, when the vehicle speed has been decelerated by braking action, the maximum possible regenerative braking force, which can be generated by the motor generator MG, tends to decrease. Furthermore, when regenerative braking action is carried out during high-speed running, a load on the inverter INV becomes high and thus a maximum regenerative braking force must be limited.

DCU 104 is configured to receive input information on accelerator opening from an accelerator opening sensor 107, vehicle speed (vehicle-body speed), calculated based on information from wheel-speed sensors 106(FL, FR, RL, RR), the battery's state of charge SOC and the like, directly or via the CAN communication line 105.

DCU 104 is also configured to execute, based on information from a variety of sensors, such as the accelerator opening sensor 107 and the like, operational control of an engine ENG, operational control of an automatic transmission (not shown), and operational control of motor generator MG based on a command to MCU 103.

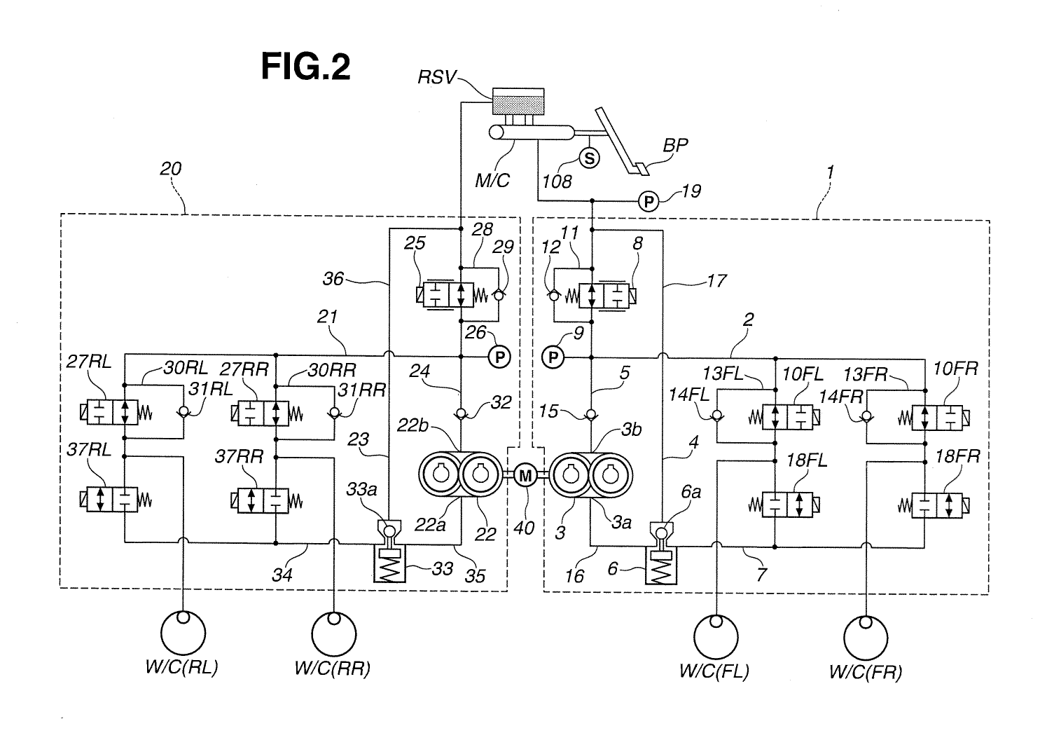

BCU 102 is configured to receive input information about a master-cylinder fluid pressure from a master-cylinder fluid-pressure sensor (see FIG. 2), a stroke amount of a brake pedal BP from a brake-pedal stroke sensor 108, each wheel speed from respective wheel-speed sensors 106(FL, FR, RL, RR), the battery's state of charge SOC, and the other quantities of state indicating a state of the vehicle (e.g., a steering angle of a steering wheel, a yaw rate acting on the host vehicle, and the like), directly or via the CAN communication line 105.

BCU 102 is also configured to calculate, based on information from a variety of sensors, such as the brake-pedal stroke sensor 108 and the like, a required braking force needed for the vehicle (all road wheels), to distribute the required braking force into a regenerative braking force and a fluid-pressure braking force, and to execute operational control of HU 101 based on a fluid-pressure-braking-force command to BCU 102 and operational control of motor generator MG based on a regenerative-braking-force command to MCU 103.

Hereupon, in the first embodiment, a higher priority is put on a regenerative braking force rather than a fluid-pressure braking force. The fluid-pressure braking force is not used, as far as the required braking force can be covered with the regenerative braking force. In other words, a used or consumed region of the regenerative braking force is enlarged to the maximum (the maximum regenerative braking force). Hence, in a particular running pattern in which accelerating and decelerating conditions repeatedly occur, an energy recovery efficiency is high, thus realizing energy recovery by means of regenerative braking to lower vehicle speeds. By the way, BCU 102 is further configured to ensure the required braking force by substituting a decrease in the regenerative braking force with a fluid-pressure braking force, when the magnitude of regenerative braking force has to be limited owing to a decrease in vehicle speed during regenerating braking.

BCU 102 calculates a required braking force responsively to an operation state of brake pedal BP of a driver during normal control, and also calculates a required braking force needed for automatic braking control responsively to information from a variety of sensors as well as an operation state of brake pedal BE during automatic braking control. Hereupon, “automatic braking control” means the following controls.

(a) anti-lock brake (ABS) control in which a vehicle-body speed (a pseudo vehicle-body speed) is estimated based on wheel speeds, and each individual fluid pressure of the wheel cylinders is increased, decreased, or held so as to bring a wheel speed of each of the road wheels FL, FR, RL, RR closer to the estimated vehicle speed (or a pressure-decrease threshold value obtained by subtracting from the estimated vehicle speed by a predetermined value);

(b) on-demand automatic brake control (auto-cruise control) in which a braking force is automatically generated according to need, when optimizing the relative velocity of the host vehicle with respect to a preceding vehicle by the auto-cruise control; and

(c) vehicle behavior stability control (vehicle dynamics control) in which, when the vehicle steer characteristic has been brought to an excessive understeer state or an excessive oversteer state during cornering of the vehicle, a yaw moment required to return to neutral steer is produced by automatically applying a braking force to a given road wheel.

BCU 102 is equipped with an automatic braking control section (an anti-lock control section) 102a for performing each of the previously-discussed ABS control, auto-cruise control, and vehicle behavior stability control.

### Circuit Configuration of HU

FIG. 2 is the hydraulic circuit diagram illustrating the circuit configuration of HU 101 in the first embodiment.

HU 101 of the first embodiment has a dual brake-circuit configuration comprised of a front-wheel system (one system) and a rear-wheel system (the other system) configured independently of each other. The front-wheel system is constructed by a brake system in which a brake fluid pressure generated by a brake operation of a driver is increased by means of a first pump 3 and the increased brake fluid pressure is supplied to wheel cylinders W/C(FL, FR), whereas the other system (the rear-wheel system) is constructed by a brake-by-wire system in which a pressure of brake fluid in a reservoir RSV is increased by means of a second pump 22 and the increased brake fluid pressure is supplied to wheel cylinders W/C(RL, RR). In the first embodiment, a gear pump is used as each of the first pump 3 and the second pump 22.

Hydraulic circuits of the front-wheel system and the rear-wheel system are hereunder explained.

(Front-Wheel System)

A booster circuit (a first brake actuating part) 1 of the front-wheel system is provided with a first hydraulic line 2 through which a master cylinder M/C is communicated with the wheel cylinders W/C(FL, FR), a first suction hydraulic line 4 branched from the first hydraulic line 2 and connected to a suction part 3a of the first pump 3, a first discharge hydraulic line 5 through which a discharge part 3b of the first pump 3 and the first hydraulic line 2 are connected each other, a storage reservoir 6 configured to store brake fluid flown out of the wheel cylinders W/C(FL, FR) with the automatic braking control section 102a operating at a pressure-decrease mode and connected to the first suction hydraulic line 4, and a first pressure-decrease hydraulic line 7 through which the storage reservoir 6 and the wheel cylinders W/C(FL, FR) are connected each other.

A master-cylinder fluid-pressure sensor 19, a gate-out valve 8, which is a normally-open proportional electromagnetic valve, a fluid-pressure sensor 9, and solenoid-in valves 10(FL, FR), each of which is a normally-open electromagnetic valve, are disposed in the first hydraulic line 2, in that order, from the side of master cylinder M/C.

Gate-out valve 8 is located on the wheel-cylinder side with respect to the junction of the first hydraulic line 2 and the first suction hydraulic line 4.

Fluid-pressure sensor 9 is located at the junction of the first hydraulic line 2 and the first discharge hydraulic line 5, for detecting a brake-fluid pressure of the discharge side of the first pump 3.

A bypass hydraulic line 11, which bypasses the gate-out valve 8, is disposed in the first hydraulic line 2. A check valve 12 is disposed in the bypass hydraulic line 11 for permitting brake-fluid flow in one direction from the master cylinder M/C to the wheel cylinders W/C(FL, FR), and for preventing (inhibiting) any flow in the opposite direction. Bypass hydraulic lines 13(FL, FR), which bypass the respective solenoid-in valves 10(FL, FR), are disposed in the first hydraulic line 2. Check valves 14(FL, FR) are disposed in the respective bypass hydraulic lines 13(FL, FR) for permitting brake-fluid flow in one direction from the wheel cylinders W/C(FL, FR) to the master cylinder M/C, and for preventing (inhibiting) any flow in the opposite direction.

A check valve 15 is disposed in the first discharge hydraulic line 5 for permitting brake-fluid flow in one direction from the discharge part 3b of the first pump 3 to the first hydraulic line 2 and for preventing (inhibiting) any brake-fluid flow in the opposite direction.

Storage reservoir 6 is equipped with a check valve 6a. Check valve 6a becomes closed when a predetermined amount of brake fluid has been stored in the storage reservoir 6 or when the hydraulic pressure in the first suction hydraulic line 4 becomes a high pressure exceeding a predetermined pressure value, thereby preventing the high pressure from being applied to the suction part 3a of the first pump 3 by preventing (inhibiting) brake fluid from flowing into the storage reservoir 6. By the way, check valve 6a becomes open regardless of a pressure in a hydraulic line 17 constructing part of the first suction hydraulic line 4 when a pressure in a hydraulic line 16 constructing part of the first suction hydraulic line 4 becomes low with the first pump 3 operated, thereby permitting brake fluid to flow into the storage reservoir 6.

Solenoid-out valves 18(FL, FR), each of which is a normally-closed electromagnetic valve, are disposed in the first pressure-decrease hydraulic line 7.

(Rear-Wheel System)

A brake-by-wire circuit (a second brake actuating part) 20 of the rear-wheel system is provided with a second hydraulic line 21 through which the reservoir RSV is communicated with the wheel cylinders W/C(RL, RR), a second suction hydraulic line 23 branched from the second hydraulic line 21 and connected to a suction part 22a of the second pump 22, a second discharge hydraulic line 24 through which a discharge part 22b of the second pump 22 and the second hydraulic line 21 are connected each other, a storage reservoir 33 configured to store brake fluid flown out of the wheel cylinders W/C(RL, RR) with the automatic braking control section 102a operating at a pressure-decrease mode and connected to the second suction hydraulic line 23, and a second pressure-decrease hydraulic line 34 through which the storage reservoir 33 and the wheel cylinders W/C(RL, RR) are connected each other.

A gate-out valve 25, which is a normally-open electromagnetic valve, a fluid-pressure sensor 26, and solenoid-in valves 27(RL, RR), each of which is a normally-open electromagnetic valve, are disposed in the second hydraulic line 21, in that order, from the side of master cylinder M/C.

Gate-out valve 25 is located on the wheel-cylinder side with respect to the junction of the second hydraulic line 21 and the second discharge hydraulic line 24.

Fluid-pressure sensor 26 is located at the junction of the second hydraulic line 21 and the second discharge hydraulic line 24, for detecting a brake-fluid pressure of the discharge side of the second pump 22.

A bypass hydraulic line 28, which bypasses the gate-out valve 25, is disposed in the second hydraulic line 21. A check valve 29 is disposed in the bypass hydraulic line 28 for permitting brake-fluid flow in one direction from the master cylinder M/C to the wheel cylinders W/C(RL, RR), and for preventing (inhibiting) any flow in the opposite direction. Bypass hydraulic lines 30(RL, RR), which bypass the respective solenoid-in valves 27(RL, RR), are disposed in the second hydraulic line 21. Check valves 31(RL, RR) are disposed in the respective bypass hydraulic lines 30(RL, RR) for permitting brake-fluid flow in one direction from the wheel cylinders W/C(RL, RR) to the master cylinder M/C, and for preventing (inhibiting) any flow in the opposite direction.

A check valve 32 is disposed in the second discharge hydraulic line 24 for permitting brake-fluid flow in one direction from the discharge part 3b of the second pump 22 to the second hydraulic line 21 and for preventing (inhibiting) any brake-fluid flow in the opposite direction.

Storage reservoir 33 is equipped with a check valve 33a. Check valve 33a becomes closed when a predetermined amount of brake fluid has been stored in the storage reservoir 33 or when the hydraulic pressure in the second suction hydraulic line 23 becomes a high pressure exceeding a predetermined pressure value, thereby preventing the high pressure from being applied to the suction part 22a of the second pump 22 by preventing (inhibiting) brake fluid from flowing into the storage reservoir 33. By the way, check valve 33a becomes open regardless of a pressure in a hydraulic line 36 constructing part of the second suction hydraulic line 23 when a pressure in a hydraulic line 35 constructing part of the second suction hydraulic line 23 becomes low with the second pump 22 operated, thereby permitting brake fluid to flow into the storage reservoir 33.

Solenoid-out valves 37(FL, FR), each of which is a normally-closed electromagnetic valve, are disposed in the second pressure-decrease hydraulic line 34.

In the first embodiment, the first pump 3 and the second pump 22 are driven by the use of a single pump motor 40 common to them.

### Regenerative Cooperation Control Processing

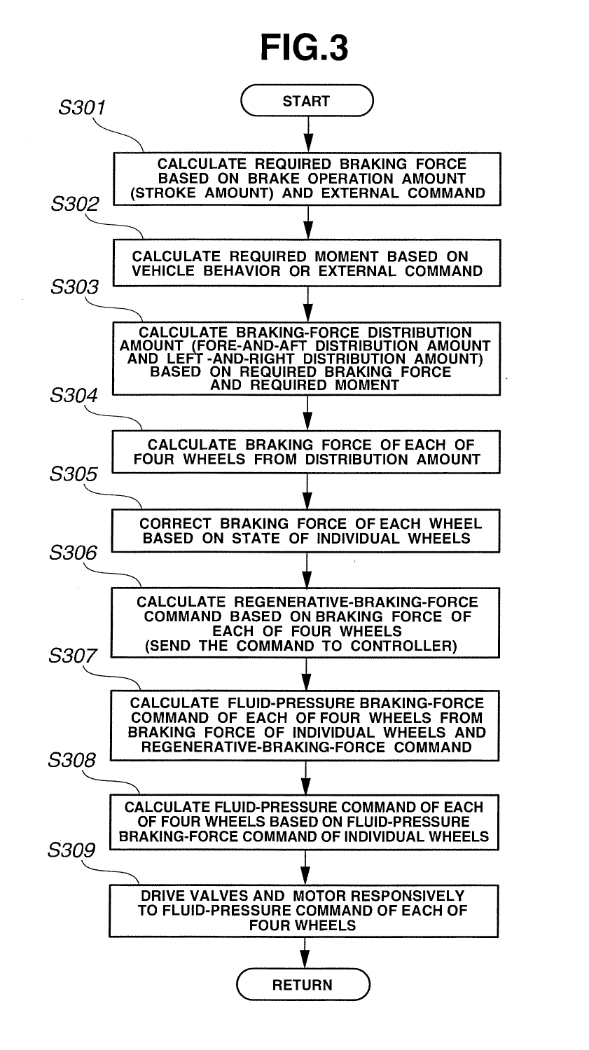

FIG. 3 is the flowchart illustrating the control flow of regenerative cooperation control processing executed within the ECU 102. Details of respective steps are hereunder described.

At step S301, a required braking force (a target braking force) is arithmetically calculated based on a brake operation amount of a driver and an external command (a command from an external controller) (a target braking force calculation section). A brake-pedal stroke amount from the brake-pedal stroke sensor 108 or a master-cylinder fluid pressure from the master-cylinder fluid-pressure sensor 19 is used as the brake operation amount.

At step S302, a required moment is arithmetically calculated based on a vehicle behavior or an external command. Hereupon, the required moment means a yaw moment that realizes or achieves a target yaw rate for vehicle dynamics control.

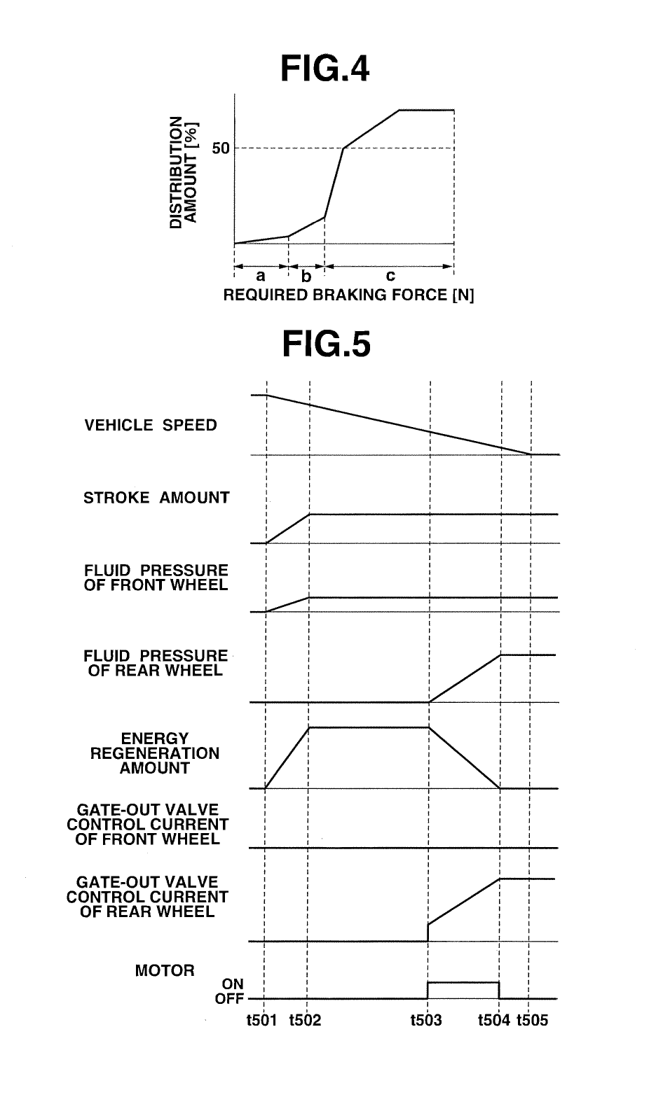

At step S303, a braking-force distribution amount (a fore-and-aft braking-force distribution amount and a left-and-right braking-force distribution amount) is arithmetically calculated based on the required braking force and the required moment. One example of the distribution amount is shown in FIG. 4. FIG. 4 is the calculation map of a fore-and-aft braking-force distribution amount during braking straight ahead. The axis of abscissa is taken as a required braking force [unit: N], whereas the axis of ordinate is taken as a fore-and-aft distribution amount [unit: %]. When the fore-and-aft distribution amount is 0%, a braking force of 0% is distributed to front-left and front-right wheels FL, FR, whereas a braking force of 100% is distributed to rear-left and rear-right wheels RL, RR. In contrast when the fore-and-aft distribution amount is 100%, a braking force of 100% is distributed to front-left and front-right wheels FL, FR, whereas a braking force of 0% is distributed to rear-left and rear-right wheels RL, RR. In the map of FIG. 4, a braking-force distribution amount of front-left and front-right wheels FL, FR with respect to a required braking force is set to increase, as the required braking force increases.

At step S304, a braking force needed for each individual road wheel is arithmetically calculated or derived from the braking-force distribution amount.

At step S305, the braking force of each individual road wheel is corrected based on a state of the individual wheels. For instance, when the ABS control system is operating, braking forces of the road wheels subjected to the anti-lock brake control are decreased.

At step S306, a regenerative-braking-force command is arithmetically calculated based on a maximum regenerative braking force received from MCU 103 and the braking force of each individual road wheel. The calculated regenerative-braking-force command is sent to the MCU 103. The regenerative-braking-force command is determined depending on a maximum possible regenerative braking force.

At step S307, a fluid-pressure braking-force command is arithmetically calculated or derived from the braking force of each individual road wheel and the regenerative-braking-force command.

At step S308, a fluid-pressure command of each individual road wheel is arithmetically calculated based on the fluid-pressure braking-force command of each individual road wheel.

At step S309, each of the valves of HU 101 and the pump motor 40 are driven responsively to the master-cylinder fluid pressure, wheel-cylinder fluid pressures (detected by fluid-pressure sensors 9, 26), and the fluid-pressure commands of each road wheel.

That is, according to regenerative cooperation control of the first embodiment, a required braking force is determined depending on a demand of the driver, and then the determined braking force of each road wheel is corrected based on a yaw moment and a state of the vehicle. Thereafter, the required braking force is distributed into a regenerative braking force and a fluid-pressure braking force, and then a regenerative-braking-force command is outputted to MCU 103 and a fluid-pressure braking-force command is outputted to HU 101.

The operation is hereunder described in detail.

FIG. 5 is the time chart illustrating the operation of HU 101 in the case that a required braking force is changing within a region “a” in FIG. 4.

At the time t501, the driver starts to operate the brake pedal BP for braking.

During the time period from the time t501 to the time t502, the brake pedal BP is further depressed by the driver and thus the brake-pedal stroke amount is increasing. A wheel-cylinder fluid pressure of each of front-left and front-right wheels FL, FR is generated in proportion to the brake-pedal stroke amount, whereas a braking force of each of rear-left and rear-right wheels RL, RR is generated only by a regenerative braking force.

At the time t502, a further depression of brake pedal BP by the driver is stopped.

During the time period from the time t502 to the time t503, the brake-pedal stroke amount is kept constant, and thus the wheel-cylinder fluid pressure of each individual road wheel is also maintained constant.

At the time t503, a limit on the regenerative braking force starts owing to a decrease in the vehicle speed.

During the time period from the time t503 to the time t504, the wheel-cylinder fluid pressure of each of rear-left and rear-right wheels RL, RR is increased by driving the pump motor 40 and by controlling an electric current flowing through the gate-out valve 25, and thus the fluid-pressure braking force is risen up in concert with a decrease rate of the regenerative braking force. Therefore, the braking force of each of rear-left and rear-right wheels RL, RR is gradually replaced or substituted from the regenerative braking force to the fluid-pressure braking force. At this time, gate-out valve 8 is kept deactivated so as not to increase the wheel-cylinder fluid pressure of each of front-left and front-right wheels FL, FR, and as a result brake fluid, discharged from the first pump 3, is returned back to the master cylinder M/C.

At the time t504, the regenerative braking force becomes zero, and whereby the substitution of the regenerative braking force with the fluid-pressure braking force becomes completed. Hence, the braking force of each of rear-left and rear-right wheels RL, RR is generated only by a fluid-pressure braking force.

At the time t505, the vehicle is put into a stop state.

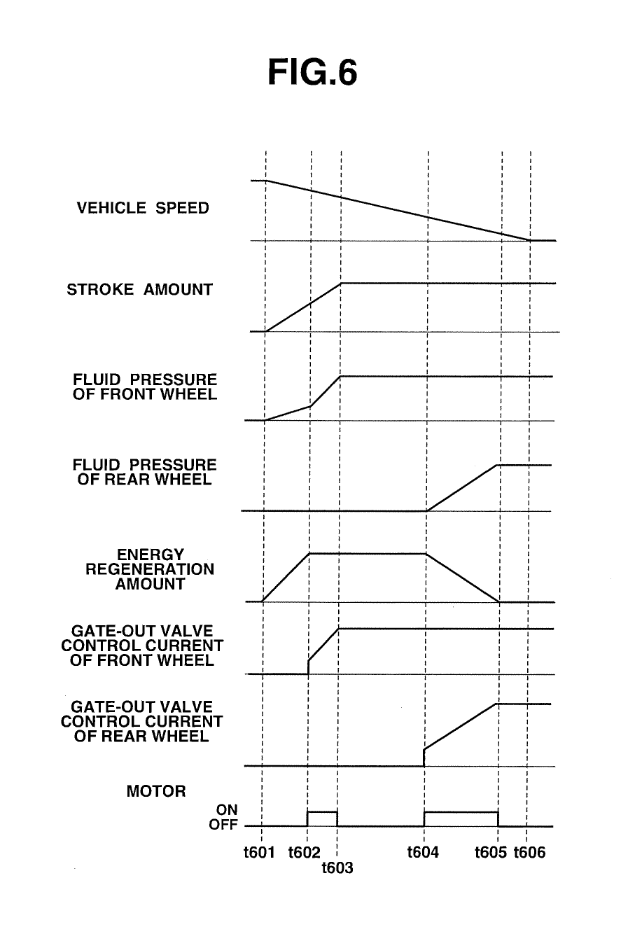

FIG. 6 is the time chart illustrating the operation of HU 101 in the case of a transition of a required braking force from the region “•” to the region “b” in FIG. 4.

At the time t601, the driver starts to operate the brake pedal BP for braking.

During the time period from the time t601 to the time t602, the brake pedal BP is further depressed by the driver and thus the brake-pedal stroke amount is increasing. A wheel-cylinder fluid pressure of each of front-left and front-right wheels FL, FR is generated in proportion to the brake-pedal stroke amount, whereas a braking force of each of rear-left and rear-right wheels RL, RR is generated only by a regenerative braking force.

At the time t602, a transition of a required braking force, calculated from the brake-pedal stroke amount, from the region “a” to the region “b” in FIG. 4 occurs.

During the time period from the time t602 to the time t603, the brake pedal BP is furthermore depressed by the driver and thus a gradient of increase in the braking force of each of front-left and front-right wheels FL, FR becomes greater than that obtained during the time period from the time t601 to the time t602. Hence, the wheel-cylinder fluid pressure of each of front-left and front-right wheels FL, FR is increased by driving the pump motor 40 and by controlling an electric current flowing through the gate-out valve 8, so as to generate the required braking force. At this time, the braking force of each of rear-left and rear-right wheels RL, RR is ensured or attained by a regenerative braking force, and hence gate-out valve 25 is kept deactivated so as not to increase the wheel-cylinder fluid pressure of each of rear-left and rear-right wheels RL, RR, and thus the brake fluid, discharged from the second pump 22, is returned back to the reservoir RSV.

At the time t603, a furthermore depression of brake pedal BP by the driver is stopped.

During the time period from the time t603 to the time t604, the wheel-cylinder fluid pressure of each of front-left and front-right wheels FL, FR is held by controlling an electric current flowing through the gate-out valve 8, so as to generate the required braking force, and the pump motor 40 is stopped.

At the time t604, a limit on the regenerative braking force starts owing to a decrease in the vehicle speed.

During the time period from the time t604 to the time t605, the wheel-cylinder fluid pressure of each of rear-left and rear-right wheels RL, RR is increased by driving the pump motor 40 and by controlling an electric current flowing through the gate-out valve 25, and thus the fluid-pressure braking force is risen up in concert with a decrease rate of the regenerative braking force. Therefore, the braking force of each of rear-left and rear-right wheels RL, RR is gradually replaced or substituted from the regenerative braking force to the fluid-pressure braking force. At this time, the electric current flowing through the gate-out valve 8 is controlled so as not to increase the wheel-cylinder fluid pressure of each of front-left and front-right wheels FL, FR, and as a result undesired brake fluid, discharged from the first pump 3, is returned back to the master cylinder M/C.

At the time t605, the regenerative braking force becomes zero, and whereby the substitution of the regenerative braking force with the fluid-pressure braking force becomes completed. Hence, the braking force of each of rear-left and rear-right wheels RL, RR is generated only by a fluid-pressure braking force.

At the time t606, the vehicle is put into a stop state.

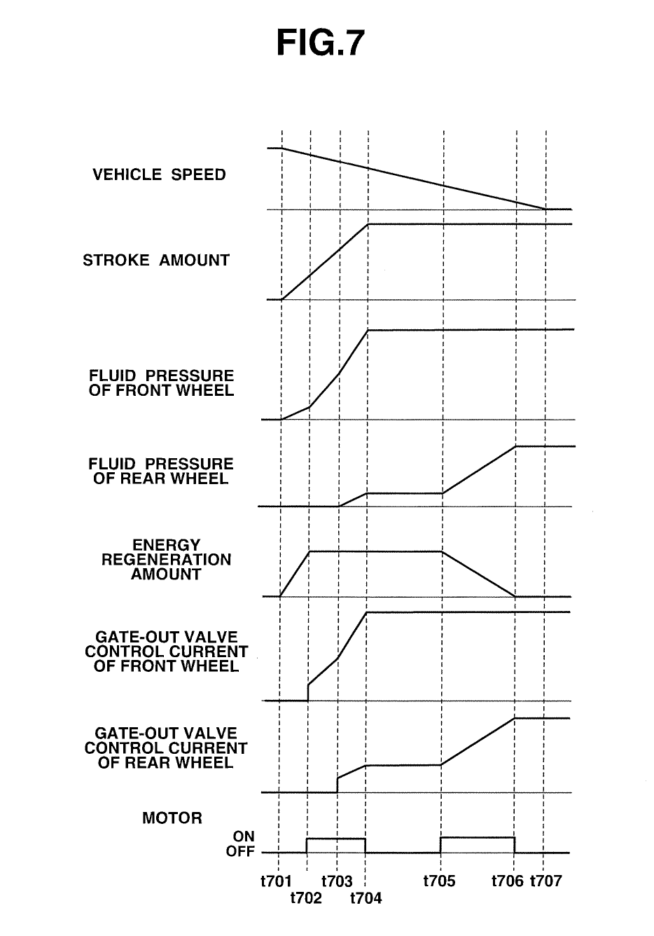

FIG. 7 is the time chart illustrating the operation of HU 101 in the case of a transition of a required braking force from the region “•” via the region “•” to the region “c” in FIG. 4.

At the time t701, the driver starts to operate the brake pedal BP for braking.

During the time period from the time t701 to the time t702, the brake pedal BP is further depressed by the driver and thus the brake-pedal stroke amount is increasing. A wheel-cylinder fluid pressure of each of front-left and front-right wheels FL, FR is generated in proportion to the brake-pedal stroke amount, whereas a braking force of each of rear-left and rear-right wheels RL, RR is generated only by a regenerative braking force.

At the time t702, a transition of a required braking force, calculated from the brake-pedal stroke amount, from the region “a” to the region “b” in FIG. 4 occurs.

During time period from the time t702 to the time t703, the brake pedal BP is furthermore depressed by the driver and thus a gradient of increase in the braking force of each of front-left and front-right wheels FL, FR becomes greater than that obtained during the time period from the time t701 to the time t702. Hence, the wheel-cylinder fluid pressure of each of front-left and front-right wheels FL, FR is increased by driving the pump motor 40 and by controlling an electric current flowing through the gate-out valve 8, so as to generate the required braking force. At this time, the braking force of each of rear-left and rear-right wheels RL, RR is ensured or attained by a regenerative braking force, and hence gate-out valve 25 is kept deactivated so as not to increase the wheel-cylinder fluid pressure of each of rear-left and rear-right wheels RL, RR, and as a result brake fluid, discharged from the second pump 22, is returned back to the reservoir RSV.

At the time t703, a transition of a required braking force, calculated from the brake-pedal stroke amount, from the region “b” to the region “c” in FIG. 4 occurs.

During the time period from the time t703 to the time t704, the brake pedal BP is still further depressed by the driver, and thus the required braking force is further increased. On the other hand, the regenerative braking force has already been reached the maximum regenerative braking force. Hence, the wheel-cylinder fluid pressure of each of rear-left and rear-right wheels RL, RR is increased by controlling an electric current flowing through the gate-out valve 25, so as to generate the required braking force.

At the time t704, a still further depression of brake pedal BP by the driver is stopped.

During the time period from the time t704 to the time t705, the wheel-cylinder fluid pressure of each of front-left and front-right wheels FL, FR is held by controlling an electric current flowing through the gate-out valve 8, and the wheel-cylinder fluid pressure of each of rear-left and rear-right wheels RL, RR are held by controlling an electric current flowing through the gate-out valve 8 and an electric current flowing through the gate-out valve 25, and the pump motor 40 is stopped.

At the time t705, a limit on the regenerative braking force starts owing to a decrease in the vehicle speed.

During the time period from the time t705 to the time t706, the wheel-cylinder fluid pressure of each of rear-left and rear-right wheels RL, RR is increased by driving the pump motor 40 and by controlling an electric current flowing through the gate-out valve 25, and thus the fluid-pressure braking force is risen up in concert with a decrease rate of the regenerative braking force. Therefore, the braking force of each of rear-left and rear-right wheels RL, RR is gradually replaced or substituted from the regenerative braking force to the fluid-pressure braking force. At this time, the electric current flowing through the gate-out valve 8 is controlled so as not to increase the wheel-cylinder fluid pressure of each of front-left and front-right wheels FL, FR, and as a result undesired brake fluid, discharged from the first pump 3, is returned back to the master cylinder M/C.

At the time t706, the regenerative braking force becomes zero, and whereby the substitution of the regenerative braking force with the fluid-pressure braking force becomes completed. Hence, the braking force of each of rear-left and rear-right wheels RL, RR is generated only by a fluid-pressure braking force.

At the time t707, the vehicle is put into a stop state.

### Enhancement of Energy Recovery Efficiency

In the conventional brake device, a brake system that uses a booster for multiplying a leg-power on a brake pedal by a driver is applied to a front-wheel system, whereas a brake-by-wire system is applied to a rear-wheel system. By the way, in the brake system, which uses a booster, a fluid-pressure braking force, which magnitude is proportional to a brake operation amount of a driver, is generated. Hence, in the front-wheel system, it is impossible to set the fluid-pressure braking force less than a fluid-pressure braking force determined based on the driver's brake operation amount and a boost ratio of the booster. Therefore, even when a regenerative braking force, produced by a regenerative braking device, does not yet reach the maximum possible regenerative braking force, the driver-required braking force has been reached due to a restriction on the front-wheel fluid-pressure braking force. Accordingly, it would be impossible to provide a greater regenerative braking force. Additionally, in the conventional brake device, the booster requires a vacuum (a negative pressure) and the like, and hence it would be impossible to apply to vehicles (electric vehicles and the like), which do not have any negative pressure source.

In contrast to the above, in the brake device of the first embodiment, a brake system in which a brake fluid pressure generated by a brake operation of a driver is increased by means of the first pump 3 and the increased brake fluid pressure is supplied to wheel cylinders W/C(FL, FR) of front-left and front-right wheels FL, FR, is applied to a front-wheel system. Therefore, as compared to the booster-equipped brake system, it is possible to set a fluid-pressure braking force of each of front-left and front-right wheels FL, FR, which is generated depending on the brake operation amount, at a smaller braking force. In other words, it is possible to set a regenerative braking force of each of rear-left and rear-right wheels RL, RR at a greater braking force, and as a result it is possible to enhance the energy recovery efficiency. Furthermore, the device of the shown embodiment eliminates the necessity of having a negative pressure source. Hence, it is possible to apply to vehicles, which do not have any negative pressure source.

Moreover, in the shown first embodiment, a brake-by-wire system in which a pressure of brake fluid in a reservoir RSV is increased by means of the second pump 22 and the increased brake fluid pressure is supplied to wheel cylinders W/C(RL, RR) of rear-left and rear-right wheels RL, RR, is applied to a rear-wheel system. A regenerative braking device, which is constructed by motor generator MG, inverter INV, and battery BAT, is provided at rear-left and rear-right wheels RL, RR. In the front-wheel system, master cylinder M/C is connected to wheel cylinders W/C(FL, FR) via the first hydraulic line 2, and thus the master-cylinder fluid pressure is risen up depending on the driver's brake operation amount. In contrast, in the rear-wheel system to which a brake-by-wire system has been applied, wheel cylinders W/C(RL, RR) are not connected to master cylinder M/C, it is possible to maintain the fluid-pressure braking force to zero regardless of the driver's brake operation amount. Hence, it is possible to cover all the braking forces of rear-left and rear-right wheels with the regenerative braking force. Accordingly, it is possible to enhance the energy recovery efficiency higher than a system in which a regenerative braking device is provided at front-left and front-right wheels FL, FR.

### Enhancement of Braking Efficiency

In the first embodiment, as seen from the map of FIG. 4, the braking-force distribution amount of front-left and front-right wheels FL, FR with respect to the required braking force increases, as the required braking force increases. Usually, a front wheel load is greater than a rear wheel load. In particular, during a decelerating condition, the position of the center of gravity of the vehicle moves to the front side of the vehicle, and thus the wheel-load difference between the front wheel load and the rear wheel load becomes remarkable. Hence, when generating the same magnitude of braking force at front and rear wheels, a workload of the front-wheel side actuator (e.g., the pump) can be reduced. Therefore, it is possible to enhance the braking efficiency by increasing the braking-force distribution amount of front-left and front-right wheels FL, FR with respect to the driver-required braking force as the driver-required braking force increases.

### Stabilization of Cornering Behavior

In the vehicle of the first embodiment, a regenerative braking force is generated at rear-left and rear-right wheels RL, RR. When the braking force of rear-left and rear-right wheels RL, RR is excessively greater than that of front-left and front-right wheels FL, FR during cornering braking, the steer characteristic of the vehicle tends to become an excessive oversteer state, and as a result the cornering behavior becomes unstable. By the way, such an oversteer tendency becomes stronger, as the braking force of the vehicle increases. Hence, it is possible to bring a fore-and-aft braking-force distribution closer to an ideal distribution (for example, Front:Rear=6:4 or 7:3) suited for vehicle specifications by increasing the braking-force distribution amount of front-left and front-right wheels FL, FR, as oversteer tendencies increase. Therefore, it is possible to stabilize the cornering behavior by suppressing oversteer tendencies.

### Fail-Safe

The brake-by-wire system is not equipped with a hydraulic circuit configuration that brake fluid, generated by the master cylinder, is supplied to wheel cylinders. Thus, it is impossible to generate a braking force when a system failure has occurred. In the first embodiment, the brake-by-wire system is applied to a rear-wheel system so that the summed braking force of a fluid-pressure braking force and a regenerative braking force is generated at rear-left and rear-right wheels RL, RR. From the viewpoint of the braking efficiency and the like, the braking force of rear wheels is set to be less than that of front wheels. Hence, even when the brake-by-wire system has failed, it is possible to ensure the required braking force by the regenerative braking force.

In contrast, the front-wheel system is equipped with a hydraulic circuit configuration that brake fluid, generated by the master cylinder M/C, is supplied to wheel cylinders W/C(FL, FR). Thus, even when the system has fallen into a specific situation where the first pump 3 and the second pump 22 cannot be operated due to a failure in pump motor 40, it is possible to generate a braking force at front-left and front-right wheels FL, FR by means of a brake operation by the driver, called “manual brake”. At this time, from the viewpoint of the previously-discussed braking efficiency, it is possible to generate a greater braking force at the front-wheel side, when compared to the manual brake executed at the rear-wheel side.

The effects are hereunder explained.

The brake device of the first embodiment can provide the effects enumerated as follows.

(1) A brake device used in a vehicle employing a regenerative braking device (motor generator MG, inverter INV, and battery BAT) for applying an electric braking force to road wheels is provided with a target braking force calculation section (step S301) configured to calculate a required braking force needed for the vehicle depending on a brake operation state of a driver, a first pump 3 configured to suck brake fluid from a master cylinder M/C for generating a brake fluid pressure by a brake operation of the driver and increase a wheel-cylinder fluid pressure of a front-wheel system so as to generate a braking force, a second pump 22 configured to suck the brake fluid from a reservoir RSV, in which the brake fluid is stored, and increase a wheel-cylinder fluid pressure of a rear-wheel system so as to generate a braking force, and a BCU 102 configured to calculate a distribution amount among the braking forces respectively produced by the first pump 3, the second pump 22, and the regenerative braking device in order to generate the required braking force. Hence, it is possible to enhance the energy recovery efficiency during braking. Also, it is possible to apply to vehicles (electric vehicles and the like), which do not have any negative pressure source.

(2) The regenerative braking device is configured to apply the braking force to rear-left and rear-right wheels RL, RR. Hence, it is possible to cover all the braking forces of rear-left and rear-right wheels RL, RR with the regenerative braking force, and thus it is possible to enhance the energy recovery efficiency higher than a system in which a regenerative braking device is provided at front-left and front-right wheels FL, FR.

(3) The BCU 102 is configured to increase the distribution amount of the braking force of the front-wheel system, as the required braking force increases. Hence, it is possible to enhance the braking efficiency. Also, it is possible to stabilize the cornering behavior by suppressing oversteer tendencies during cornering braking.

(4) The front-wheel system is constructed by a brake system in which the brake fluid pressure generated by the brake operation of the driver is increased by means of the first pump and the increased brake fluid pressure is supplied to the wheel cylinders W/C(FL, FR), whereas the rear-wheel system is constructed by a brake-by-wire system in which a pressure of brake fluid in the reservoir RSV is increased by means of the second pump and the increased brake fluid pressure is supplied to the wheel cylinders W/C(RL, RR). Hence, even when the brake-by-wire system has failed, it is possible to ensure the required braking force by the regenerative braking force. Also, it is possible to generate a greater braking force at the front-wheel side, when compared to the manual brake executed at the rear-wheel side.

(5) The BCU 102 is configured to determine the distribution amount based on the required braking force, such that a braking force needed for the rear-wheel system is generated by a regenerative braking force produced by the regenerative braking device and a fluid-pressure braking force produced by the second pump 22. Hence, it is possible to always enhance the regenerative braking force up to a maximum possible regenerative braking force, and thus a high energy recovery efficiency can be achieved. Additionally, even when one of the brake-by-wire system and the regenerative braking device has failed, it is possible to ensure the required braking force by a braking force produced by the other.

(6) The BCU 102 is configured to calculate the distribution amount among the braking forces respectively produced by the first pump 3, the second pump 22, and the regenerative braking device, such that the regenerative braking force of the regenerative braking device can be obtained when the brake operation is started. Hence, it is possible to realize energy recovery by means of regenerative braking from the early part of braking.

### Second Embodiment

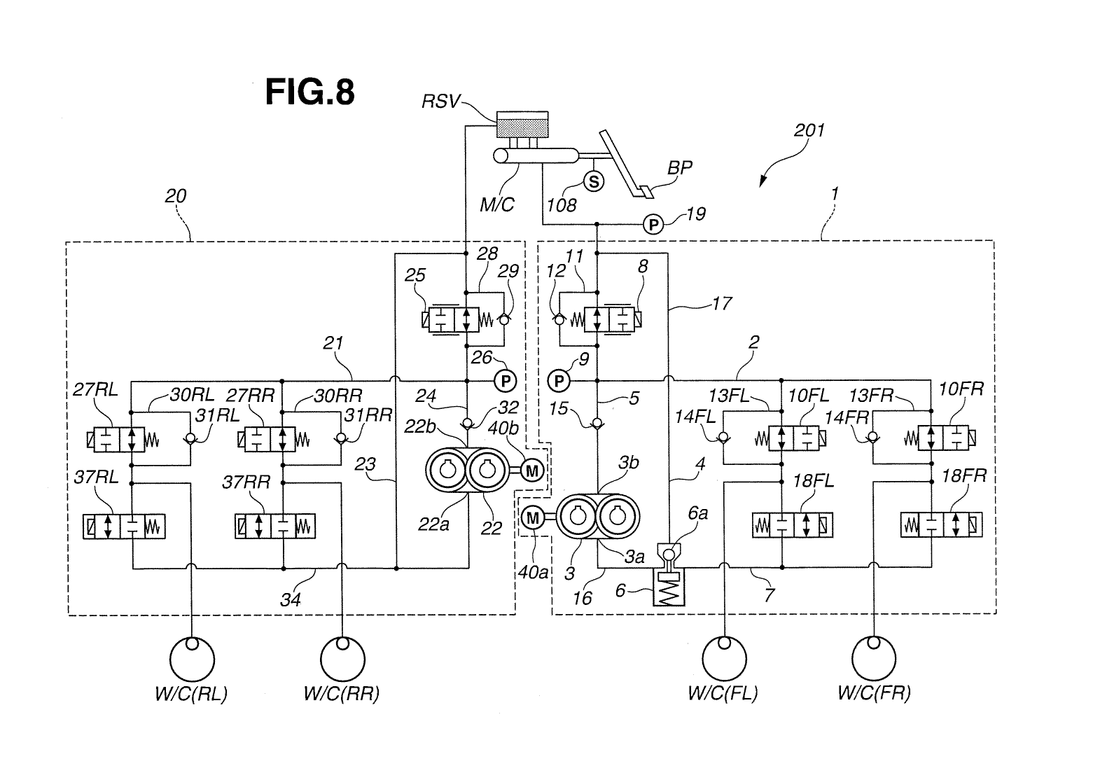

FIG. 8 is the hydraulic circuit diagram illustrating the circuit configuration of a hydraulic control unit (HU) 201 in the second embodiment. In explaining the second embodiment of FIG. 8, the same reference signs used to designate elements in the HU 101 of the first embodiment shown in FIG. 2 will be applied to the corresponding elements used in the second embodiment, while detailed description of the same reference signs will be omitted because the above description thereon seems to be self-explanatory.

The second embodiment differs from the first embodiment, as follows:

In the second embodiment, the first pump 3 and the second pump 22 are driven independently of each other by means of a first pump motor (a first motor) 40a and a second pump motor (a second motor) 40b, respectively. Additionally, a storage reservoir is not disposed in the second suction hydraulic line 23 of the rear-wheel system, and in lieu thereof the second suction hydraulic line 23 and the second pressure-decrease hydraulic line 34 are connected directly with each other.

In the case of HU 201 of the second embodiment, when a wheel-cylinder fluid pressure increase in the front-wheel system is required, only the first pump motor 40a is driven without driving the second pump motor 40b. Conversely when a wheel-cylinder fluid pressure increase in the rear-wheel system is required, only the second pump motor 40b is driven without driving the first pump motor 40a. Hence, when increasing a wheel-cylinder fluid pressure in one system, it is possible to prevent a pressure of brake fluid from being undesirably increased via the hydraulic circuit of the other system.

Additionally, any storage reservoir is not provided in the brake-by-wire circuit 20. Thus, it is possible to reduce the number of component parts, in comparison with a system in which a storage reservoir is provided in the brake-by-wire circuit 20.

The effects are hereunder explained.

The brake device of the second embodiment can provide the effects enumerated as follows, in addition to the effects (1)-(6) of the first embodiment.

(7) A first pump motor 40a for driving the first pump 3 and a second pump motor 40b for driving the second pump 22 are provided. Hence, when increasing a wheel-cylinder fluid pressure in one system, it is possible to prevent a pressure of brake fluid from being undesirably increased via the hydraulic circuit of the other system.

(8) The BCU 102 is provided with an automatic braking control section 102a. The booster circuit 1 is provided with a first hydraulic line 2 through which the master cylinder M/C is communicated with the wheel cylinders W/C(FL, FR), a first suction hydraulic line 4 branched from the first hydraulic line 2 and connected to a suction part 3a of the first pump 3, a first discharge hydraulic line 5 through which a discharge part 3b of the first pump 3 and the first hydraulic line 2 are connected each other, a storage reservoir 6 configured to store brake fluid flown out of the wheel cylinders W/C(FL, FR) with the automatic braking control section 102a operating at a pressure-decrease mode and connected to the first suction hydraulic line 4, and a first pressure-decrease hydraulic line 7 through which the storage reservoir 6 and the wheel cylinders W/C(FL, FR) are connected each other. The brake-by-wire circuit 20 is provided with a second hydraulic line 21 through which the reservoir RSV is communicated with the wheel cylinders W/C(RL, RR), a second suction hydraulic line 23 branched from the second hydraulic line 21 and connected to a suction part 22a of the second pump 22, and a second discharge hydraulic line 24 through which a discharge part 22b of the second pump 22 and the second hydraulic line 21 are connected each other. Hence, it is possible to reduce production costs because of the reduced number of component parts, as compared to a system in which a storage reservoir is provided in the brake-by-wire circuit 20.

### Third Embodiment

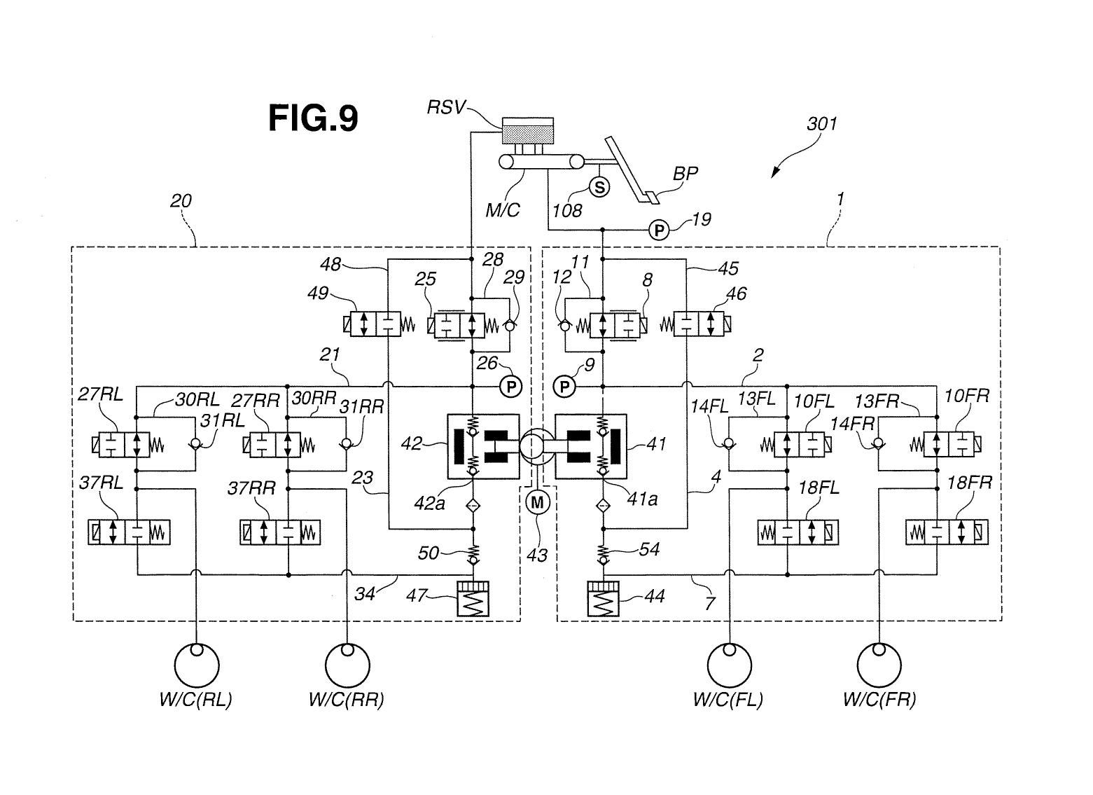

FIG. 9 is the hydraulic circuit diagram illustrating the circuit configuration of a hydraulic control unit (HU) 301 in the third embodiment. In explaining the third embodiment of FIG. 9, the same reference signs used to designate elements in the HU 101 of the first embodiment shown in FIG. 2 will be applied to the corresponding elements used in the third embodiment, while detailed description of the same reference signs will be omitted because the above description thereon seems to be self-explanatory.

In the case of the HU 301 of the third embodiment, a plunger pump is used as a first pump 41 and a second pump 42. These two pumps 41, 42 are driven by a single pump motor 43 common to them.

In the booster circuit 1, the master cylinder M/C and a suction part 41a of the first pump 41 are connected with each other by a first suction hydraulic line 45 not through a storage reservoir 44. A gate-in valve 46, which is a normally-closed electromagnetic valve, is disposed in the first suction hydraulic line 45. A check valve 54 is disposed between the first suction hydraulic line 45 and the storage reservoir 44, for permitting brake-fluid flow in one direction from the storage reservoir 44 to the suction part 41a of the first pump 41, and for preventing (inhibiting) any flow in the opposite direction.

In the brake-by-wire circuit 20, the reservoir RSV and a suction part 42a of the second pump 42 are connected with each other by a second suction hydraulic line 48 not through a storage reservoir 47. A gate-in valve 49, which is a normally-closed electromagnetic valve, is disposed in the second suction hydraulic line 48. A check valve 50 is disposed between the second suction hydraulic line 48 and the storage reservoir 47, for permitting brake-fluid flow in one direction from the storage reservoir 47 to the suction part 42a of the second pump 42, and for preventing (inhibiting) any flow in the opposite direction.

In the case of HU 301 of the third embodiment, when a wheel-cylinder fluid pressure increase in the front-wheel system is required, brake fluid is supplied to the first pump 41 by driving the pump motor 43 and by controlling an electric current flowing through the gate-in valve 46. At this time, gate-in valve 49 remains deactivated, and thus it is possible to prevent a pressure increase of brake fluid, caused by the second pump 42.

Conversely when a wheel-cylinder fluid pressure increase in the rear-wheel system is required, brake fluid is supplied to the second pump 42 by driving the pump motor 43 and by controlling an electric current flowing through the gate-in valve 49. At this time, gate-in valve 46 remains deactivated, and thus it is possible to prevent a pressure increase of brake fluid, caused by the first pump 42.

The effects are hereunder explained.

The brake device of the third embodiment can provide the effects enumerated as follows, in addition to the effects (1)-(6) of the first embodiment.

(9) Gate-in valves 46, 49, each of which is a normally-closed electromagnetic valve, are disposed in the first suction hydraulic line 45 and the second suction hydraulic line 48, respectively. Hence, when increasing a wheel-cylinder fluid pressure in one system, it is possible to prevent a pressure of brake fluid from being undesirably increased via the hydraulic circuit of the other system.

### Fourth Embodiment

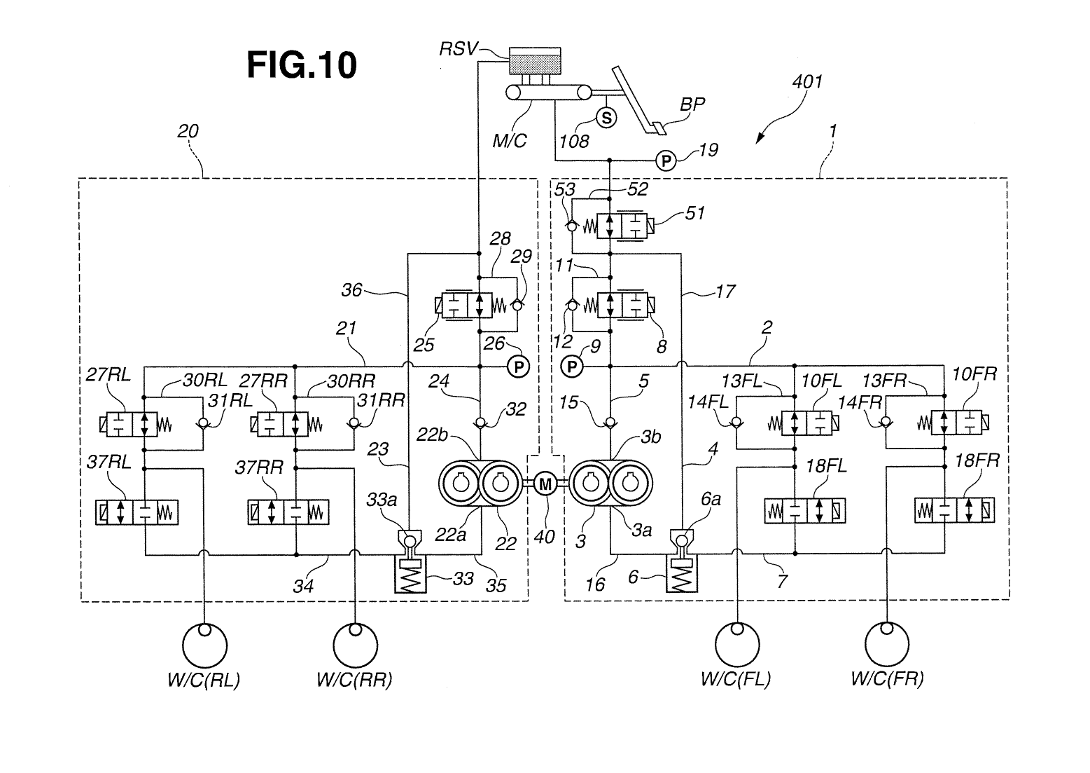

FIG. 10 is the hydraulic circuit diagram illustrating the circuit configuration of a hydraulic control unit (HU) 401 in the fourth embodiment. In explaining the fourth embodiment of FIG. 10, the same reference signs used to designate elements in the HU 101 of the first embodiment shown in FIG. 2 will be applied to the corresponding elements used in the fourth embodiment, while detailed description of the same reference signs will be omitted because the above description thereon seems to be self-explanatory.

The fourth embodiment differs from the first embodiment, as follows:

In the case of the HU 401 of the fourth embodiment, a pulse-pressure reduction valve (a pulse-pressure reduction means) 51, which is a normally-open proportional electromagnetic valve, is located on the side of master cylinder M/C with respect to the junction of the first hydraulic line 2 and the first suction hydraulic line 4. A bypass hydraulic line 52, which bypasses the pulse-pressure reduction valve 51, is disposed in the first hydraulic line 2. A check valve 53 is disposed in the bypass hydraulic line 52 for permitting brake-fluid flow in one direction from the master cylinder M/C to the wheel cylinders W/C(RL, RR), and for preventing (inhibiting) any flow in the opposite direction.

In the case of HU 401 of the fourth embodiment, when a wheel-cylinder fluid pressure increase in only the rear-wheel system is required, a reflux circuit, which returns or recirculates brake fluid discharged from the discharge part 3a of the first pump 3 back to the suction part 3b of the first pump 3, is configured or established by a portion of the first hydraulic line 2 and a portion of the first suction hydraulic line 4 both located on the side of first pump 3 with respect to the pulse-pressure reduction valve 51, by controlling an electric current flowing through the pulse-pressure reduction valve 51 and by closing the fluid-flow path through which the master cylinder M/C communicates with the suction part 3a of the first pump 3. Hence, it is possible to suppress fluid-pressure pulsations caused by operation of the first pump 3, from being propagated to the side of master cylinder M/C, thereby reducing a deterioration of pedal feel.

The effects are hereunder explained.

The brake device of the fourth embodiment can provide the effects enumerated as follows, in addition to the effects (1)-(6) of the first embodiment.

(10) A pulse-pressure reduction valve 51 is disposed in the first hydraulic line 2 and located between the branch point of the first hydraulic line 2 from the first suction hydraulic line 4 and the master cylinder M/C for absorbing fluid-pressure pulsations caused by the first pump 3. Hence, it is possible to suppress fluid-pressure pulsations caused by operation of the first pump 3, from being propagated to the side of master cylinder M/C, thereby reducing a deterioration of pedal feel.

### Fifth Embodiment

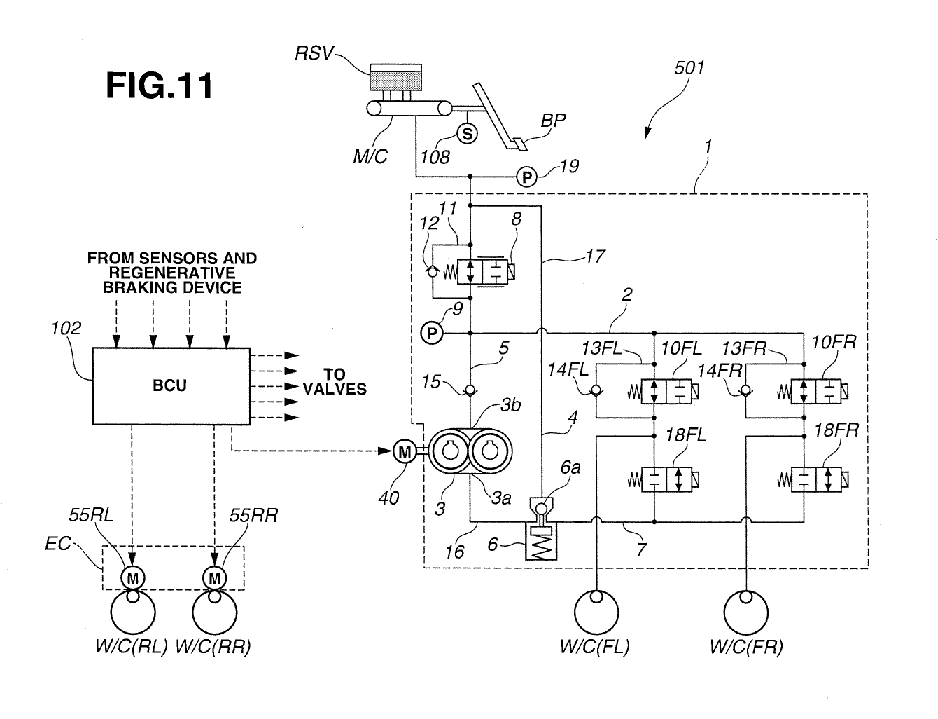

FIG. 11 is the hydraulic circuit diagram illustrating the circuit configuration of a hydraulic control unit (HU) 501 in the fifth embodiment. In explaining the fifth embodiment of FIG. 11, the same reference signs used to designate elements in the HU 101 of the first embodiment shown in FIG. 2 will be applied to the corresponding elements used in the fifth embodiment, while detailed description of the same reference signs will be omitted because the above description thereon seems to be self-explanatory.

The HU 501 of the fifth embodiment differs from the previously-discussed other embodiments, in that an electric-motor driven caliper EC is used for the rear-wheel system. In the electric-motor driven caliper EC, wheel-brake pistons are moved by the use of respective motors 55RL, 55RR, such that the pistons push the pads (brake shoes) into contact with respective brake rotors to generate a braking force.

Therefore, the front-wheel system is constructed by the use of a hydraulic circuit configuration, whereas the rear-wheel system is constructed by the use of an electric brake system. Hence, it is possible to carry out controls suited for respective characteristics of the front-wheel system and the rear-wheel system, thereby enhancing the controllability.

### Other Embodiments

While the foregoing is a description of the preferred embodiments carried out the invention, it will be understood that the invention is not limited to the particular embodiments shown and described herein, but that various changes and modifications may be made without departing from the scope or spirit of this invention.

In the shown embodiments, booster circuit 1 is provided at the front-wheel system, whereas brake-by-wire circuit 20 is provided at the rear-wheel system. Also exemplified is the regenerative braking device provided at rear wheels. In lieu thereof, booster circuit 1 may be provided at the rear-wheel system, brake-by-wire circuit 20 may be provided at the front-wheel system, and the regenerative braking device may be provided at front wheels.

The technical ideas grasped from the embodiments shown and described are enumerated, as follows:

(a) In the brake device as recited in claim 5, the brake device is characterized in that the control unit is configured to determine the distribution amount, such that the regenerative braking force of the regenerative braking device can be obtained when the brake operation is started.

Hence, it is possible to realize energy recovery by means of regenerative braking from the early part of braking.

(b) In a brake device used in a vehicle employing a regenerative braking device for applying an electric braking force to road wheels, the brake device is characterized by a target braking force calculation section configured to calculate a target braking force depending on a brake operation state of a driver, a first brake actuating part equipped with a first pump configured to suck brake fluid from a master cylinder for generating a brake fluid pressure by a brake operation of the driver and increase a wheel-cylinder fluid pressure of one system of a first system and a second system of the vehicle so as to generate a braking force, the first system and the second system being configured independently of each other, a second brake actuating part equipped with a second pump configured to suck the brake fluid from a reservoir, in which the brake fluid is stored, and increase a wheel-cylinder fluid pressure of the other system of the first system and the second system so as to generate a braking force, and a control unit configured to determine a distribution amount among the braking forces respectively produced by the first brake actuating part, the second brake actuating part, and the regenerative braking device in order to generate the calculated target braking force and control the first brake actuating part and the second brake actuating part to achieve the determined distribution amount. Hence, it is possible to enhance the energy recovery efficiency during braking. Also, it is possible to apply to vehicles (electric vehicles and the like), which do not have any negative pressure source.

(c) In the brake device as recited in the technical idea (b), the brake device is characterized in that the regenerative braking device is configured to apply the braking force to each of the road wheels attached to the other system.

Hence, it is possible to cover all the braking forces of the road wheels attached to the other system with the regenerative braking force. Accordingly, it is possible to enhance the energy recovery efficiency higher than a system in which a regenerative braking device is provided at the one system.

(d) In the brake device as recited in the technical idea (c), the brake device is characterized in that the one system is a left-and-right front-wheel system of the vehicle, whereas the other system is a left-and-right rear-wheel system of the vehicle.

Hence, even when the second brake actuating part has failed, it is possible to ensure the required braking force (target braking force) by the regenerative braking force. Additionally, it is possible to generate a greater braking force at the one system, when compared to the manual brake executed at the other system.

(e) In the brake device as recited in the technical idea (d), the brake device is characterized in that a first motor for driving the first pump and a second motor for driving the second pump are provided.

Hence, when increasing a wheel-cylinder fluid pressure in the one system, it is possible to prevent a pressure of brake fluid from being undesirably increased via the hydraulic circuit of the other system.

(f) In the brake device as recited in the technical idea (e), the brake device is characterized in that the control unit is provided with an anti-lock control section, and the first brake actuating part is provided with a first hydraulic line through which the master cylinder is communicated with the wheel cylinders of the one system, a first suction hydraulic line branched from the first hydraulic line and connected to a suction part of the first pump, a first discharge hydraulic line through which a discharge part of the first pump and the first hydraulic line are connected each other, a storage reservoir configured to store brake fluid flown out of the wheel cylinders of the one system with the anti-lock control section operating at a pressure-decrease mode and connected to the first suction hydraulic line, and a first pressure-decrease hydraulic line through which the storage reservoir and the wheel cylinders of the one system are connected each other, and the second brake actuating part is provided with a second hydraulic line through which the reservoir is communicated with the wheel cylinders of the other system, a second suction hydraulic line branched from the second hydraulic line and connected to a suction part of the second pump, and a second discharge hydraulic line through which a discharge part of the second pump and the second hydraulic line are connected each other. Hence, it is possible to reduce production costs because of the reduced number of component parts, as compared to a system in which a storage reservoir is provided in the second brake actuating part.

(g) In the brake device as recited in the technical ideal (f), the brake device is characterized by a pulse-pressure reduction means disposed in the first hydraulic line and located between a branch point of the first hydraulic line from the first suction hydraulic line and the master cylinder for absorbing fluid-pressure pulsations caused by the first pump. Hence, it is possible to suppress fluid-pressure pulsations caused by operation of the first pump, from being propagated to the master-cylinder side, thereby reducing a deterioration of pedal feel.

(h) In the brake device as recited in the technical idea (c), the brake device is characterized in that the control unit is provided with an anti-lock control section, and the first brake actuating part is provided with a first hydraulic line through which the master cylinder is communicated with the wheel cylinders of the one system, a first suction hydraulic line branched from the first hydraulic line and connected to a suction part of the first pump, a first discharge hydraulic line through which a discharge part of the first pump and the first hydraulic line are connected each other, a storage reservoir configured to store brake fluid flown out of the wheel cylinders of the one system with the anti-lock control section operating at a pressure-decrease mode and connected to the first suction hydraulic line, and a first pressure-decrease hydraulic line through which the storage reservoir and the wheel cylinders of the one system are connected each other, and the second brake actuating part is provided with a second hydraulic line through which the reservoir is communicated with the wheel cylinders of the other system, a second suction hydraulic line branched from the second hydraulic line and connected to a suction part of the second pump, and a second discharge hydraulic line through which a discharge part of the second pump and the second hydraulic line are connected each other. Hence, it is possible to reduce production costs because of the reduced number of component parts, as compared to a system in which a storage reservoir is provided in the second brake actuating part.

(i) In the brake device as recited in the technical idea (c), the brake device is characterized in that a first motor for driving the first pump and a second motor for driving the second pump are provided.

Hence, when increasing a wheel-cylinder fluid pressure in the one system, it is possible to prevent a pressure of brake fluid from being undesirably increased via the hydraulic circuit of the other system.

(j) In a brake device used in a vehicle employing a regenerative braking device for applying an electric braking force to road wheels, the brake device is characterized in that a booster circuit equipped with a first pump configured to suck brake fluid from a master cylinder for generating a brake fluid pressure corresponding to a force of a brake operation by a driver without multiplying the brake operation and increase a wheel-cylinder fluid pressure of one system of a first system and a second system of the vehicle so as to generate a braking force, the first system and the second system being configured independently of each other, and a brake-by-wire circuit equipped with a second pump configured to suck the brake fluid from a reservoir, in which the brake fluid is stored, and increase a wheel-cylinder fluid pressure of the other system of the first system and the second system so as to generate a braking force.

Hence, it is possible to enhance the energy recovery efficiency during braking. Also, it is possible to apply to vehicles (electric vehicles and the like), which do not have any negative pressure source.

(k) In the brake device as recited in the technical idea (j), the brake device is characterized by a target braking force calculation section configured to calculate a target braking force depending on a state of the brake operation of the driver, and a control unit configured to calculate a distribution amount among the braking forces respectively produced by the booster circuit, the brake-by-wire circuit, and the regenerative braking device in order to generate the calculated target braking force.

Hence, it is possible to enhance the energy recovery efficiency during braking.

(l) In the brake device as recited in the technical idea (k), the brake device is characterized in that the regenerative braking device is configured to apply the braking force to each of the road wheels attached to the other system.

Hence, it is possible to cover all the braking forces of the road wheels attached to the other system with the regenerative braking force. Accordingly, it is possible to enhance the energy recovery efficiency higher than a system in which a regenerative braking device is provided at the one system.

(m) In the brake device as recited in the technical idea (j), the brake device is characterized in that the one system is a left-and-right front-wheel system of the vehicle, whereas the other system is a left-and-right rear-wheel system of the vehicle.

Hence, even when the steer-by-wire circuit has failed, it is possible to ensure the required braking force (target braking force) by the regenerative braking force. Additionally, it is possible to generate a greater braking force at the one system, when compared to the manual brake executed at the other system.

(n) In the brake device as recited in the technical idea (j), the brake device is characterized in that a first motor for driving the first pump and a second motor for driving the second pump are provided.

Hence, when increasing a wheel-cylinder fluid pressure in the one system, it is possible to prevent a pressure of brake fluid from being undesirably increased via the hydraulic circuit of the other system.

(o) In the brake device as recited in the technical idea (j), the brake device is characterized in that the control unit is provided with an anti-lock control section, and the booster circuit is provided with a first hydraulic line through which the master cylinder is communicated with the wheel cylinders of the one system, a first suction hydraulic line branched from the first hydraulic line and connected to a suction part of the first pump, a first discharge hydraulic line through which a discharge part of the first pump and the first hydraulic line are connected each other, a storage reservoir configured to store brake fluid flown out of the wheel cylinders of the one system with the anti-lock control section operating at a pressure-decrease mode and connected to the first suction hydraulic line, and a first pressure-decrease hydraulic line through which the storage reservoir and the wheel cylinders of the one system are connected each other, and the brake-by-wire circuit is provided with a second hydraulic line through which the reservoir is communicated with the wheel cylinders of the other system, a second suction hydraulic line branched from the second hydraulic line and connected to a suction part of the second pump, and a second discharge hydraulic line through which a discharge part of the second pump and the second hydraulic line are connected each other.

Hence, it is possible to reduce production costs because of the reduced number of component parts, as compared to a system in which a storage reservoir is provided in the brake-by-wire circuit.

### REFERENCE SIGNS LIST

3 First pump
22 Second pump
41 First pump
42 Second pump
102 Brake control unit (Control unit)
BAT Battery (Regenerative braking device)
INV Inverter (Regenerative braking device)
M/C Master cylinder
MG Motor generator (Regenerative braking device)
RSV Reservoir
S301 Target braking force calculation section
W/C Wheel cylinder

1. A brake device used in a vehicle employing a regenerative braking device for applying an electric braking force to road wheels comprising:
a target braking force calculation section configured to calculate a target braking force depending on a brake operation state of a driver;
a first brake part configured to suck brake fluid from a master cylinder for generating a brake fluid pressure by a brake operation of the driver and increase a wheel-cylinder fluid pressure of one system of a first system and a second system of the vehicle so as to generate a braking force, the first system and the second system being configured independently of each other;
a second brake part configured to apply a braking force to the other system of the first system and the second system; and
a control unit configured to determine a distribution amount among the braking forces respectively produced by the first brake part, the second brake part, and the regenerative braking device in order to generate the calculated target braking force.

2. A brake device as recited in claim 1, wherein:
the regenerative braking device is configured to apply the braking force to each of the road wheels attached to the other system.

3. A brake device as recited in claim 2, wherein:
the control unit is configured to increase the distribution amount of the braking force of the one system, as the calculated target braking force increases.

4. A brake device as recited in claim 3, wherein:
the master cylinder is configured without interposing a brake booster between a brake pedal operated by the brake operation of the driver and the master cylinder; and
the one system is a left-and-right front-wheel system of the vehicle, whereas the other system is a left-and-right rear-wheel system of the vehicle.

5. A brake device as recited in claim 4, wherein:
the second brake part is a second pump configured to suck the brake fluid from a reservoir, in which the brake fluid is stored, and increase a wheel-cylinder fluid pressure of the other system of the first system and the second system so as to generate the braking force; and
the control unit is configured to determine the distribution amount based on the calculated target braking force, such that a braking force needed for the other system is generated by the braking force produced by the regenerative braking device and the braking force produced by the second pump.

6. A brake device as recited in claim 5, wherein:
the control unit is configured to determine the distribution amount, such that the braking force of the regenerative braking device can be obtained when the brake operation is started.

7. A brake device used in a vehicle employing a regenerative braking device for applying an electric braking force to road wheels, comprising:
a target braking force calculation section configured to calculate a target braking force depending on a brake operation state of a driver;
a first brake actuating part equipped with a first pump configured to suck brake fluid from a master cylinder for generating a brake fluid pressure by a brake operation of the driver and increase a wheel-cylinder fluid pressure of one system of a first system and a second system of the vehicle so as to generate a braking force, the first system and the second system being configured independently of each other;
a second brake actuating part equipped with a second pump configured to suck the brake fluid from a reservoir, in which the brake fluid is stored, and increase a wheel-cylinder fluid pressure of the other system of the first system and the second system so as to generate a braking force; and
a control unit configured to determine a distribution amount among the braking forces respectively produced by the first brake actuating part, the second brake actuating part, and the regenerative braking device in order to generate the calculated target braking force and control the first brake actuating part and the second brake actuating part to achieve the determined distribution amount.

8. A brake device as recited in claim 7, wherein:
the regenerative braking device is configured to apply the braking force to each of the road wheels attached to the other system.

9. A brake device as recited in claim 8, wherein:
the one system is a left-and-right front-wheel system of the vehicle, whereas the other system is a left-and-right rear-wheel system of the vehicle.

10. A brake device as recited in claim 9, which further comprises:
a first motor for driving the first pump and a second motor for driving the second pump.

11. A brake device as recited in claim 10, wherein:
the control unit comprises an anti-lock control section;
the first brake actuating part comprises:
a first hydraulic line through which the master cylinder is communicated with the wheel cylinders of the one system;
a first suction hydraulic line branched from the first hydraulic line and connected to a suction part of the first pump;
a first discharge hydraulic line through which a discharge part of the first pump and the first hydraulic line are connected each other;
a storage reservoir configured to store brake fluid flown out of the wheel cylinders of the one system with the anti-lock control section operating at a pressure-decrease mode and connected to the first suction hydraulic line; and
a first pressure-decrease hydraulic line through which the storage reservoir and the wheel cylinders of the one system are connected each other; and
the second brake actuating part comprises:
a second hydraulic line through which the reservoir is communicated with the wheel cylinders of the other system;
a second suction hydraulic line branched from the second hydraulic line and connected to a suction part of the second pump; and
a second discharge hydraulic line through which a discharge part of the second pump and the second hydraulic line are connected each other.

12. A brake device as recited in claim 11, which further comprises:
a pulse-pressure reduction means disposed in the first hydraulic line and located between a branch point of the first hydraulic line from the first suction hydraulic line and the master cylinder for absorbing fluid-pressure pulsations caused by the first pump.

13. A brake device as recited in claim 8, wherein:
the control unit comprises an anti-lock control section;
the first brake actuating part comprises:
a first hydraulic line through which the master cylinder is communicated with the wheel cylinders of the one system;
a first suction hydraulic line branched from the first hydraulic line and connected to a suction part of the first pump;
a first discharge hydraulic line through which a discharge part of the first pump and the first hydraulic line are connected each other;
a storage reservoir configured to store brake fluid flown out of the wheel cylinders of the one system with the anti-lock control section operating at a pressure-decrease mode and connected to the first suction hydraulic line; and
a first pressure-decrease hydraulic line through which the storage reservoir and the wheel cylinders of the one system are connected each other; and
the second brake actuating part comprises:
a second hydraulic line through which the reservoir is communicated with the wheel cylinders of the other system;
a second suction hydraulic line branched from the second hydraulic line and connected to a suction part of the second pump; and
a second discharge hydraulic line through which a discharge part of the second pump and the second hydraulic line are connected each other.

14. A brake device as recited in claim 8, which further comprises:
a first motor for driving the first pump and a second motor for driving the second pump.

15. A brake device used in a vehicle employing a regenerative braking device for applying an electric braking force to road wheels, comprising:
a booster circuit equipped with a first pump configured to suck brake fluid from a master cylinder for generating a brake fluid pressure corresponding to a force of a brake operation by a driver without multiplying the brake operation and increase a wheel-cylinder fluid pressure of one system of a first system and a second system of the vehicle so as to generate a braking force, the first system and the second system being configured independently of each other; and
a brake-by-wire circuit equipped with a second pump configured to suck the brake fluid from a reservoir, in which the brake fluid is stored, and increase a wheel-cylinder fluid pressure of the other system of the first system and the second system so as to generate a braking force.

16. A brake device as recited in claim 15, which further comprises:
a target braking force calculation section configured to calculate a target braking force depending on a state of the brake operation of the driver; and
a control unit configured to calculate a distribution amount among the braking forces respectively produced by the booster circuit, the brake-by-wire circuit, and the regenerative braking device in order to generate the calculated target braking force.

17. A brake device as recited in claim 16, wherein:
the regenerative braking device is configured to apply the braking force to each of the road wheels attached to the other system.

18. A brake device as recited in claim 16, wherein:
the one system is a left-and-right front-wheel system of the vehicle, whereas the other system is a left-and-right rear-wheel system of the vehicle.

19. A brake device as recited in claim 16, which further comprises:
a first motor for driving the first pump and a second motor for driving the second pump.

20. A brake device as recited in claim 16, wherein:
the control unit comprises an anti-lock control section;
the booster circuit comprises:
a first hydraulic line through which the master cylinder is communicated with the wheel cylinders of the one system;
a first suction hydraulic line branched from the first hydraulic line and connected to a suction part of the first pump;
a first discharge hydraulic line through which a discharge part of the first pump and the first hydraulic line are connected each other;
a storage reservoir configured to store brake fluid flown out of the wheel cylinders of the one system with the anti-lock control section operating at a pressure-decrease mode and connected to the first suction hydraulic line; and
a first pressure-decrease hydraulic line through which the storage reservoir and the wheel cylinders of the one system are connected each other; and
the brake-by-wire circuit comprises:
a second hydraulic line through which the reservoir is communicated with the wheel cylinders of the other system;
a second suction hydraulic line branched from the second hydraulic line and connected to a suction part of the second pump; and
a second discharge hydraulic line through which a discharge part of the second pump and the second hydraulic line are connected each other.
